(19) United States
(12) Patent Application Publication
(10) Pub. No.: US 2019/0321919 A1
(43) Pub. Date: Oct. 24, 2019

(54) Weakening Device and Method for Weakening Packaging Materials

(71) Applicant: SIG Technology AG, Neuhausen am Rheinfall (CH)

(72) Inventors: Daniel Cappel, Heinsberg (DE); Gerhard Rempel, Baesweiler (DE); Jörg Steinfels, Grevenbroich (DE)

(21) Appl. No.: 16/464,846

(22) PCT Filed: Oct. 19, 2017
(86) PCT No.: PCT/EP2017/076722

§ 371 Date: May 29, 2019

(30) Foreign Application Priority Data
Nov. 30, 2016 (DE) 10 2016 123 077.4

(51) Int. Cl. B23K 26/364; B23K 26/03; B23K 26/067; B23K 26/082; B23K 26/08; B23K 26/14; B23K 26/16; B23K 26/402; B31B 50/25

(52) U.S. Cl. CPC B23K 26/364; B23K 26/032; B23K 26/0673; B23K 26/082; B23K 2101/16; B23K 26/147; B23K 26/16; B23K 26/402; B31B 50/25; B23K 26/0846

(57) ABSTRACT

Described is a weakening device for weakening packaging materials having at least one laser unit comprising a laser having a laser beam and at least one transport device for transport of the packaging material relative to the laser unit. The laser unit has at least one focusing optics for focusing the laser beam on the packaging material transported relative to the laser. In order to be able to inscribe both straight lines of weakness and shapes included from lines, it is provided that the laser unit has at least one scanner for adjusting the laser beam at least in one direction transversely to the transport direction for inscribing predetermined shapes into the packaging material transported past the laser, and that a beam switch is provided in the path of the laser beam for transmitting the beam to the focusing optics in a liner position or to the scanner.

The invention relates to an weakening device for weakening packaging materials, in particular packaging laminates, having at least one laser unit comprising a laser for irradiating and partially removing the packaging material with a laser beam and at least one transport device for, in particular continuous, transport of the packaging material relative to the laser unit, wherein the at least one laser unit has at least one focussing optics for focussing the laser beam on the packaging material transported by the transport device relative to the laser. Furthermore, the invention relates to a method for weakening packaging materials, in particular packaging laminates.

Weakening devices are used to weaken packaging materials at certain points or along what are known as lines of weakness, by removing a part of the packaging material. The packaging formed from the weakened packaging material can then for example easily be torn open along the line of weakness, in order to access the content of the packaging. The lines of weakness can be inscribed into the packaging material quite accurately and quite quickly with a laser. The laser locally heats the packaging material and thus leads to a local vaporisation of parts of the packaging material. The vaporisation of parts of the packaging material may result in unvaporised parts of the packaging material being blast off. Since the packaging materials are intended to form packaging, the lasers typically do not penetrate through the entire layer thickness of the packaging material, but only reduce the layer thickness of the packaging material along the line of weakness. In order to avoid the introduction of too much energy into the packaging material and thus prevent the rigidity and strength of the packaging along the line of weakness being impaired too much, the depth of the line of weakness in the packaging material can vary.

Packaging laminates are particularly used as packaging materials. The layer structure of the packaging laminates can be used to absorb the laser beam in a specific laminate layer. In addition, a laminate layer can be provided, which is only slightly effected by the laser beam or not at all. In this way, the depth of the line of weakness can be set or limited in a targeted manner.

Packaging laminates include, for example, a cardboard layer and outer, especially thermoplastic, plastic layers, such as polyethylene (PE) or polypropylene (PP). The carton provides the packaging with sufficient stability to allow the packages to easily be handled and stacked, for example. The plastic layers protect the carton from moisture and the food from absorbing unwanted substances from the package. In addition, other layers, such as an aluminium layer, may be provided to prevent diffusion of oxygen and other gases through the packaging material.

Such packaging laminates are often formed into packages that are open on one side, which are then filled and sealed into packaging. The packages are regularly filled with foodstuffs, especially flowable foodstuffs, such as drinks. However, before forming the packages open on one side, if required lines of weakness are inscribed in the packaging material, for example, to open the packaging subsequently along the lines of weakness.

The laser units of known weakening devices have a focussing device in order to focus the laser beam very precisely and on a very small area. Thus, a large amount of area-specific energy can be introduced almost punctiform into the packaging material. In this way, the line of weakness can be inscribed very quickly into the packaging material, without appreciably affecting adjacent areas of the packaging material. For the sake of simplicity, the packaging material is guided past the laser unit of the weakening device via a transport device and thereby inscribed with the line of weakness.

A disadvantage of the corresponding lines of weakness is that they can only be inscribed into the packaging material with the laser unit as straight lines, if necessary dashed. Laser units are also known which can deflect the laser beam in order to inscribe a shape into the packaging material with the line of weakness, for example to provide defined openings for spouts or the like. However, in order to inscribe such lines of weakness, the weakening devices must be expensively converted. Although appropriately converted weakening devices can in principle also inscribe straight lines of weakness, this is less quick and less precise than is possible with focussing optics that are not designed for deflecting the laser beam.

Therefore, the present invention has the object of designing and further developing the above-mentioned and previously described weakening device and method in such a way that it will be possible to inscribe both straight lines of weakness as well as shapes more accurately and more quickly into packaging material.

This object is achieved in an weakening device according to the preamble of claim 1, in that the laser unit has at least one scanner for adjusting the laser beam at least in one direction transversely to the transport direction for inscribing predetermined shapes into the packaging material transported past the laser, and in that a beam switch is provided in the beam path of the laser beam in the laser unit, which optionally transmits the laser beam in a liner position to the focussing optics or in a scanner position to the scanner.

Furthermore, the stated object is achieved according to claim 11 by a method for weakening packaging materials, in particular packaging laminates,
in which the packaging material is transported past at least one laser unit by a transport device, in particular continuously,
in which the laser unit produces a laser beam for irradiating and partially removing packaging material, and
in which the laser beam is optionally directed by a beam switch in a liner position to a focussing optics for focussing the laser beam on the packaging material or in a scanner position to a scanner for adjusting the laser beam at least in one direction transverse to the transport direction for inscribing predetermined shapes on the packaging material.

The invention has recognised that packaging materials can be provided very expediently with different lines of weakness in different ways, for example in order to meet different customer requirements, if the laser unit has at least one scanner and one focussing optics, wherein it can then be determined via the position of a beam switch whether the laser beam may be directed subsequent to the beam switch to the focussing optics, which may be designed to be movable with respect to their position to the laser unit and/or the packaging material, or to the scanner. The laser unit is thus designed to inscribe rectilinear lines of weakness in the liner position of the beam switch very quickly and precisely into the packaging material transported past the laser beam via the transport device. In addition, by adjusting the beam switch into the scanner position, it is possible to inscribe more complex lines of weakness into the packaging material, for example straight lines or curved lines, said lines extending at least partially transversely to the transport direction of the packaging material in the region of the laser beam impinging the packaging material.

The scanner is designed so that the scanner can divert the laser beam passing through the scanner very quickly relative to the transport speed of the packaging material transported past the laser unit in a varying manner at least transversely to the transport direction of the packaging material. Thus, it is possible to achieve not simply a constant deflection of the laser beam, as is the case with a conventional deflection mirror. The nature or extent of the deflection varies with the transport of the packaging material, so as to inscribe a line of weakness in the form of a shape into the packaging material, which extends at least also transversely to the transport direction of the packaging material. If the packaging material is transported continuously past the laser unit, it must be noted that the laser beam must be moved both in the transport direction of the packaging material and perpendicular to the transport direction and parallel to the packaging material in order to produce a line of weakness which is exclusively perpendicular to the transport direction of the packaging material and parallel to the packaging material. Thus, the movement direction of the laser beam relative to the scanner or to the laser unit is not identical to the direction of the line of weakness inscribed by the laser beam into the packaging material. However, the movement direction and the movement speed of the laser beam relative to the scanner or to the laser unit, together with the transport speed of the packaging material web in the region of the laser unit, define the shape of the line of weakness on the packaging material.

The shape created with the scanner can be inscribed continuously in succession. However, it will be preferable in many cases for the same shapes to be constantly inscribed at the same constant intervals from each other in the packaging material. In this case, the shape is preferably always inscribed from the same starting point to a specific endpoint. The control of the weakening device would however, if necessary, also allow successively different, in particular individual, shapes to be inscribed in the packaging material. Since, however, the same packaging is usually to be produced from the packaging materials, this is provided and desired only in special cases.

However, the laser beam can also be directed, if required, via the beam switch provided in the beam path of the laser beam, through the at least one focussing optics instead of the scanner, if two-dimensional shapes are not required to be inscribed into the packaging material by means of the line of weakness. For focussing, the focussing optics can, if necessary, be adjusted, in particular moved, completely or partially along the beam path, such as in the direction of the laser beam or opposite thereto. Two-dimensional shapes are understood here as meaning those in which the at least one line of weakness extends at least also in a direction perpendicular to the transport direction of the packaging material and parallel to the packaging material. A line of weakness running in the transport direction of the packaging material, with a significant elongation perpendicular thereto, both parallel to the packaging material and perpendicular to the packaging material, does not form a two-dimensional shape in the present sense, but rather a one-dimensional shape.

A laborious and time-consuming conversion of the weakening device can be omitted, if it is necessary to switch between one-dimensional and two-dimensional shapes to be inscribed by means of lines of weakness. Only the beam switch needs be adjusted in such a way that the laser beam is optionally directed through the at least one focussing optics or through the scanner, depending on which type of shape is to be inscribed in the packaging material by means of at least one of the lines of weakness.

Regardless of the shape of the lines of weakness, this can be introduced consistently with constant depth into the packaging material. In order not to affect the stability and strength too much, the depth at which a line of weakness is inscribed into a packaging material may vary along the line of weakness. It can also be provided that the line of weakness is executed dashed or dotted, in which case in particular short, recessed sections of the line of weakness follow and alternate with in particular short, non-recessed sections of the line of weakness. Very long non-recessed sections between two recessed sections, however, can be designed so that there is a plurality of lines of weakness spaced apart from each other, in particular when the recessed sections are formed at least substantially similar at least in their direction, if necessary, also in their depth.

For the sake of clarity and to avoid unnecessary repetition, the weakening device and the method for weakening packaging materials will be inscribed below together, without always respectively distinguishing in detail between the weakening device and the method. However, from the context it will be apparent to those skilled in the art which particular features are preferred with respect to the method and the weakening device.

In a first particularly preferred embodiment of the weakening device, the scanner has at least one mirror which is adjustably arranged in the beam path for adjusting the laser beam reflected by the mirror. The mirror can preferably be designed to be pivotable about at least one axis. The pivoting of the mirror can be simple, precise and fast, in order to inscribe two-dimensional shapes by means of at least one line of weakness very quickly or in a packaging material moving very rapidly. In order to achieve a varying deflection of the laser beam in at least one further direction, the at least one pivotable mirror can be pivotable about at least two pivot axes which are not parallel, in particular are perpendicular, to each other. However, this makes the suspension and the drive of the mirror quite complex, so that it may be preferable to provide the scanner with at least two mutually inclined mirrors, in particular at least substantially adjustable in vertical directions. The installation of multiple mirrors is in principle more complex, but these can be configured and adjusted more easily overall. For example, one mirror can effect an adjustment of the laser beam in one direction and another mirror can adjust the laser beam in another direction so as to inscribe a two-dimensional shape into the packaging material by means of at least one line of weakness. For simple control of the scanner unit, at least one mirror may be configured for adjusting the laser beam in the transport direction of the packaging material (x-direction) and at least one other mirror may be configured for adjusting the laser beam in a direction perpendicular to the transport direction and parallel to the packaging material (y-direction), As a result of a continuous transport of the packaging material past the laser unit, an adjustment of the laser beam in the x-direction and in the y-direction is necessary for inscribing a line of weakness exclusively perpendicular to the transport direction (y-direction). A distinction is therefore made between the direction of the adjustment of the laser beam and the direction of the line of weakness inscribed in the packaging material in this way.

For the sake of simple structural design and simple and quick adjustability, the adjustment of the at least one mirror in one direction can be realised as a pivoting about at least one pivot axis. If necessary, the at least one mirror can be pivotable about two mutually inclined, in particular at least substantially mutually vertically arranged, pivot axes. Preferably, however, for the sake of easier adjustability in particular, one mirror should be provided in the beam path of the laser beam, which is pivotable about an axis, while a further mirror should be arranged in the beam path of the laser beam, which is pivotable about another pivot axis. The two pivot axes are aligned at least substantially perpendicular to one another to make the process simpler to control.

The redirecting of the laser beam by means of the beam switch optionally to the focussing optics and past the scanner or to the scanner and past the focussing optics can be achieved very easily and at the same time very accurately with a long service life of the beam switch, if the beam switch itself is configured to be adjustable at least from a liner position for directing the laser beam to the focussing optics, into a scanner position for directing the laser beam to the scanner and back. In other words, the beam switch is physically adjusted in order to deflect the laser beam, in particular correspondingly. This is particularly simple when a rotatable deflection mirror is adjusted, if necessary, together with the beam switch itself. The deflection mirror can thus be provided fixed in the beam switch and can be adjusted together with the beam switch itself. As a result, damage or deviations of the deflection mirror can be avoided. The beam switch can simply be made so stable and durable that the beam switch survives many adjustment cycles without damage. The deflection mirror can, if necessary, but also be adjusted separately. To adjust the beam switch or the deflection mirror, an electric drive may preferably be provided. Thus, an accurate and reliable adjustment of the beam switch can be achieved and integrated in particular in a control concept or a controller.

To simplify the adjustment of the beam switch and to ensure that the beam switch can always be reliably adjusted, the use of at least one stop for the beam switch is advantageous. The at least one stop can be provided so that the beam switch and/or the at least one deflection mirror of the beam switch rests against the stop in the liner position and/or the scanner position. In this case, the at least one stop can form an end stop for the adjusting movement of the beam switch. Then the adjustment path is limited in at least one direction by the end stop.

For simple and reliable adjustment of the beam switch between the liner position and the scanner position, alternatively or additionally, the use of a pneumatic drive is suitable. Thus, if necessary merely by pressurising the drive, an adjustment of the beam switch can be brought about. The use of a double piston drive has been found to be particularly expedient. Thus, if necessary, the adjustment of the beam switch into the liner position can be effected by the pressurisation of one piston, and the adjustment of the beam switch into the scanner position can be effected by pressurisation of the other piston.

In this case, the end position of the beam switch or of the at least one deflection mirror of the beam switch can be determined in the liner position and/or in the scanner position by an end position of the at least one piston of the pneumatic drive. The end position of the at least one piston can then be regarded as the stop, in particular the end stop of the beam switch.

In order to avoid contamination or disturbance of the laser unit by the packaging material removed by the laser during inscribing of the line of weakness, an extractor hood can be arranged between the laser unit and the area of the packaging material inscribed by the laser. The extractor hood is then provided in the beam path of the laser between the laser unit and the packaging material. Preferably, the extractor hood is provided adjacent to the packaging material, so that a gap for sucking in fresh air is formed between the extractor hood and the packaging material, which replaces the air extracted from the extractor hood. In order for the laser beam to be able to inscribe a line of weakness in the part of the packaging material covered by the extractor hood, the laser unit can additionally or alternatively have a housing section which is transparent to the laser beam and through which the laser beam can pass. Impurities, such as removed packaging material, can thus be kept away from the laser unit. It is particularly expedient if the extractor hood adjoins the transparent housing section or comprises the transparent housing section. Thus, a housing section transparent to the laser beam is provided for the laser beam to enter the extractor hood. The corresponding transparent area is then preferably provided so that the inscribing of the packaging material can be carried out without an additional deflection of the laser beam in the extractor hood.

Also, the laser beam manipulated by the scanner in its beam direction should preferably be focused on the packaging material. It therefore makes sense to provide a focussing optics in the beam path that passes through the scanner. Since the laser beam covers a different path between the at least one scanner and the packaging material, depending on the deflection in the transport direction of the packaging material (x-direction) and perpendicular thereto as well as parallel to the packaging material (y-direction), the focus in the beam direction of the laser beam (z-direction) should be adjusted so that the focus is always on the plane of the packaging material independent of the deflection of the laser beam through the scanner and thus independent of the path length of the beam path of the laser for impinging the packaging material. In other words, the focussing optics associated with the scanner for focussing the laser beam can be aligned perpendicular to the packaging material, in particular depending on the deflection of the laser beam through the scanner, wherein the deflection can be understood as a deflection in the x-direction and/or in the y-direction.

In order to simplify the alignment of the laser beam generated by the laser unit with the beam switch in the liner position with respect to the packaging material, at least the laser, the beam switch, the at least one focussing optics and/or the scanner of the at least one laser unit can be fixed relative to each other on a holding device of the laser unit. The holding device can be designed for simplicity as a holding plate or as a housing. Thus, the laser unit can be mounted in the appropriate position, without the mounting position being fixed and without an adjustment of the optics being required. Furthermore, it is expedient if the holding device is mounted adjustably in at least one direction. The laser unit can then be displaced approximately along at least one rail until the exact positioning is achieved. This can then be fixed to the at least one rail in the appropriate position of the laser unit.

In many cases, packaging materials with multiple uses are produced side-by-side. This means that packaging material sections for producing different packages are arranged next to one another on the packaging material. The packaging material can be cut longitudinally at a subsequent time to obtain the different packaging material sections. In other words, the packaging material web can have a plurality of adjacent rows of packaging material sections, which are respectively provided for the production of a packaging. In order to provide these packaging materials quickly and efficiently with the lines of weakness associated with the different package sections, it is advisable if at least two, in particular at least four or at least six, laser units are provided. These can be arranged adjacent to one another partially in a direction perpendicular to the transport direction of the packaging material and parallel to the packaging material. Likewise, it is alternatively or additionally possible to provide the laser units one behind the other at least partially in the transport direction of the packaging material. For example, the laser units can be arranged offset one behind the other in a confined space. However, the adjacent packaging materials to be processed do not necessarily have several different uses. It can also be the case that packaging materials with only a single use are used and weakened locally by means of a laser. In the case of packaging materials with a single use, it is preferred, if necessary, if only one laser unit is provided for processing the packaging material, in particular for introducing lines of weakness into the packaging material.

So that the packaging materials are provided with the at least one line of weakness at the designated location or so that the two-dimensional shapes to be inscribed into the packaging material by means of the line of weakness can be inscribed precisely into the packaging material and at the respectively designated intervals, it is expedient to detect a reference position on the packaging material, for example in the form of a control mark, and to determine from the successively detected reference positions, if necessary, a transport speed of the packaging material. In a preferred embodiment, the control mark is a printed mark, that is to say a printed control mark, and/or an embossed mark, that is to say a control mark embossed in the packaging material. In principle, however, any control mark that could be detected in a suitable manner may be used. Since the lines of weakness should usually be provided at a certain position of the subsequent packaging, it makes sense to detect recurrently a certain position of the packaging material, which is arranged at the same place in all subsequent packaging. In other words, a reference position or a control mark can be detected at intervals, which correspond to the distances of the subsequent packaging blanks produced from the packaging material web. For ease of detection of the reference position or the control mark, a sensor, in particular optical, can be provided for the sake of simplicity for detecting reference positions or control marks provided on the packaging material. This is particularly useful in the case of printed marks and/or embossed marks. For reliable control of the process, it is further expedient if a control device is provided for controlling the scanner dependent on the detection, in particular the time of detection, of the reference points or control marks by the sensor. The difference between a reference point and a control mark can lie in the fact that the control mark has been printed on the packaging material as a printed mark or introduced into the packaging material as an embossed mark, while a reference position is provided for other reasons at the corresponding points of the packaging material and at the same time is detectable as such. If necessary, reference positions are available anyway and do not have to be additionally provided for creating a control mark.

In terms of method, in a particularly preferred embodiment, the energy of the laser beam impinging the packaging material is varied at least temporarily. This can be done regardless of whether the beam switch is arranged in the liner position or in the scanner position. Due to the varying energy of the laser beam, the inscribed line of weakness can be inscribed into the packaging material with correspondingly varying depths. Thus, therefore, it is possible to vary or even time the laser beam such that different amounts of packaging material are removed at different points in the packaging material or the line of weakness. With a pulsating laser, for example, the pulse length and/or the pulse rate can be varied in order to vary the energy introduced into the packaging material by the laser beam. If necessary, the focus can also be adjusted in order to vary the energy density or the surface-specific energy of the laser beam on the packaging material. Alternatively or additionally, in the case of corresponding lasers, the energy of the laser beam itself may possibly also be varied.

In order to inscribe the at least one line of weakness into the packaging material for specific applications in respectively suitable manners, it makes sense for a laser beam passing through the beam switch in the liner position to inscribe into the packaging material a line of weakness which is parallel to the transport direction of the packaging material, while a laser beam passing through the beam switch in the scanner position inscribes into the packaging material a line of weakness which runs at least partially in the direction perpendicular to the transport direction and parallel to the packaging material.

The laser beam, which is directed via the scanner and thereby inscribes a shape into the packaging material from at least one line of weakness, is adjusted in at least one direction (y-direction). If necessary, this is accompanied by an adjustment of the laser beam in another direction, for example in a direction perpendicular to the y-direction, in particular in the x-direction. For this purpose, a single mirror can be used to save space. However, it is simpler if the deflection takes place in any direction (e.g., x-direction and/or y-direction) with a separate mirror.

In order to produce similar packaging, it is preferred if, by means of a laser beam passing through the beam switch in the scanner position, spaced-apart shapes are inscribed in the packaging material by means of at least one line of weakness. The distances of these shapes can more preferably be regular. Likewise, similar packaging can be achieved in particular if the inscribed shapes are also similar. Alternatively, it may be preferable for the same reason for the production of other packages, to inscribe a straight line of weakness in the packaging material, in particular parallel to the transport direction of the packaging material, by means of a laser beam passing through the beam switch in the liner position. So that the packaging material is not weakened too much and maintains sufficient strength, the line of weakness, whether inscribed with the beam switch in the liner position or in the scanner position, can be provided interrupted in sections, and in particular be inscribed interrupted at regular intervals. This interruption may define individual lines of weakness or result in a line of weakness of varying depth, in particular a dashed or dotted line of weakness.

Alternatively or additionally, the exact positioning of the at least one line of weakness can be achieved in that the inscribing one of a line of weakness, part of a line of weakness and/or a shape is being initiated by identifying at least one control mark, in particular a printed mark and/or embossed mark, or by identifying at least one reference position by at least one sensor. For this purpose, a corresponding sensor for detecting the control mark, the reference position and/or a control device for controlling the process for inscribing the at least one line of weakness into the packaging material may be advantageous.

So that the focus of the laser beam always lies on the packaging material, even if the laser beam is deflected by the scanner in the x-direction and/or in the y-direction with respect to a starting position, a laser beam passing through the beam switch in the scanner position can be focussed by means of a focussing optics in accordance with the deflection of the laser beam in the transport direction of the packaging material and/or in accordance with the deflection of the laser beam in a direction perpendicular to the transport direction of the packaging material and parallel to the packaging material. For simplicity, this can be achieved for example by displacing the focussing optics or a part thereof, in particular a lens, along the beam path of the laser beam. In a simple case, the length adjustment of the focussing optics may correspond or be proportional to the change in length of the laser beam in relation to the starting position of the laser beam.

The invention will subsequently be explained in more detail with reference to a drawing depicting only exemplary embodiments. The following are shown in the drawing:

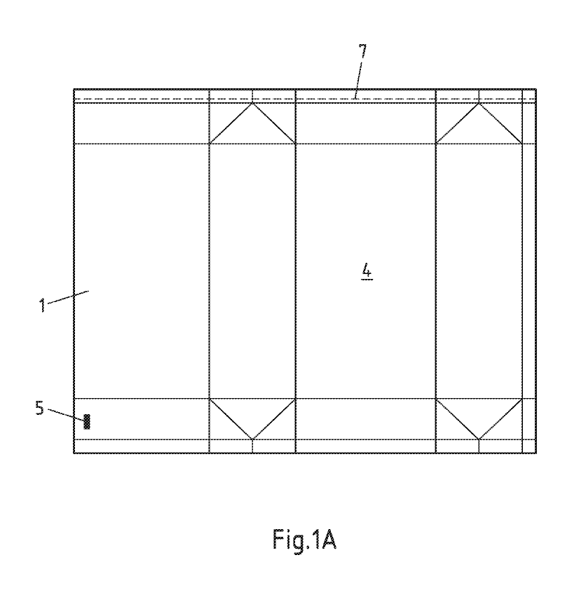

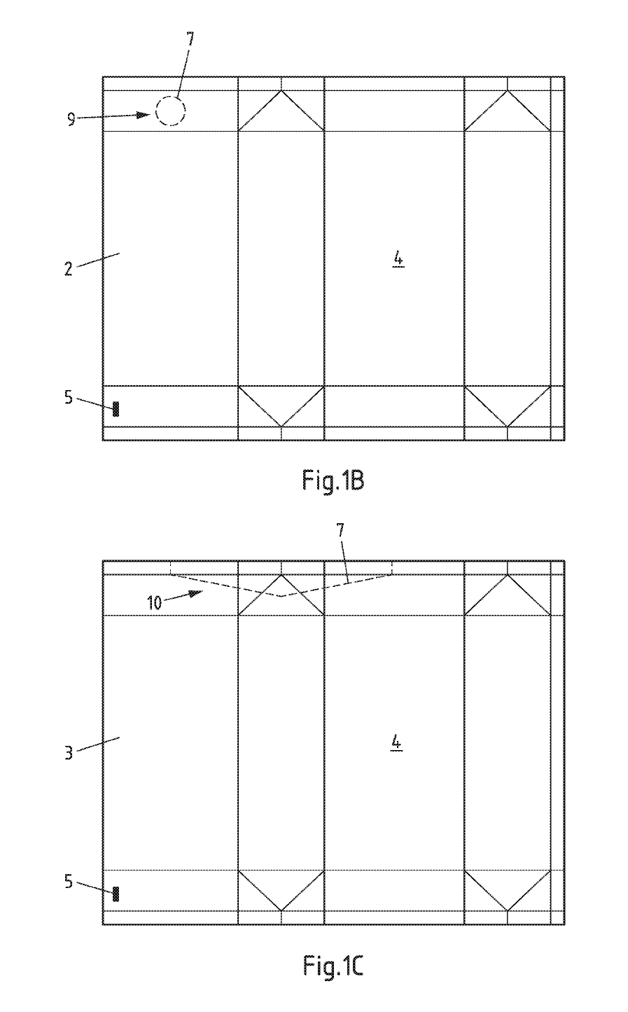

FIG. 1A-C packaging blanks cut from packaging material webs produced with the weakening device according to the present invention and the method according to the present invention for forming a package, in plan view,

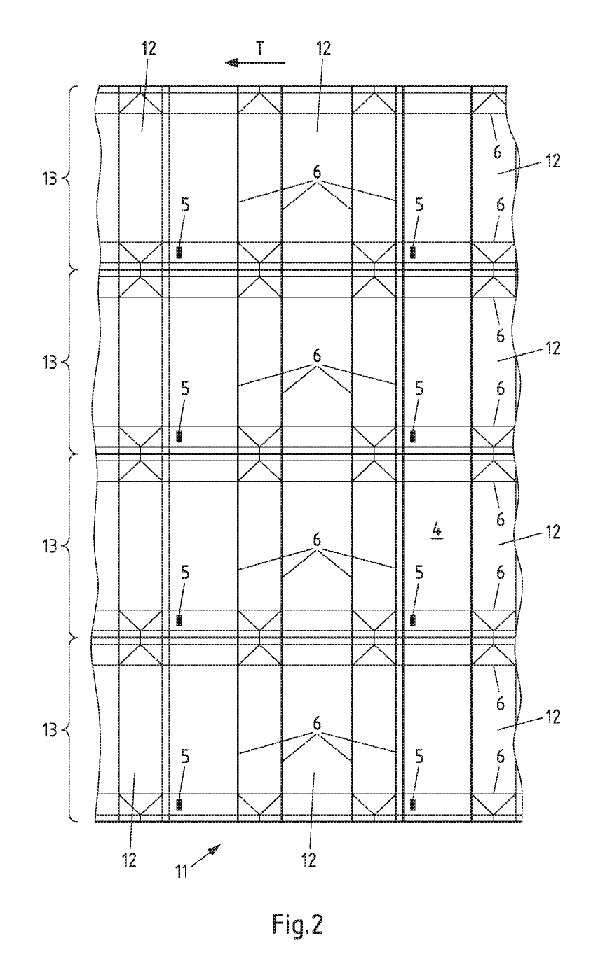

FIG. 2 a packaging material web used by the weakening device according to the invention and in the method according to the invention,

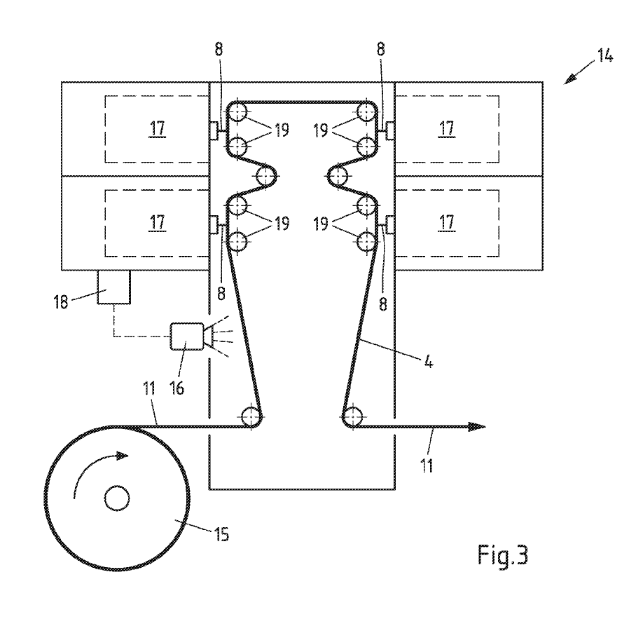

FIG. 3 an weakening device according to the invention while carrying out the method according to the invention with a packaging material web according to FIG. 2 in a schematic side view,

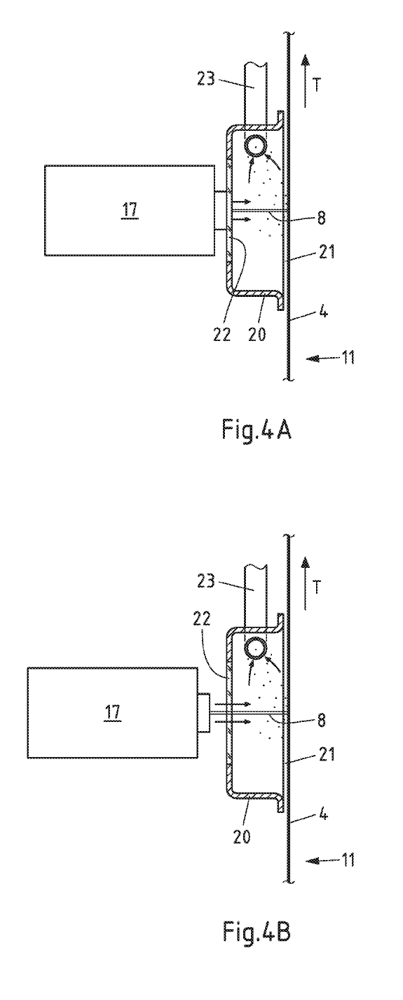

FIG. 4A-B a detail of the weakening device from FIG. 3 and an alternative weakening device in a schematic side view,

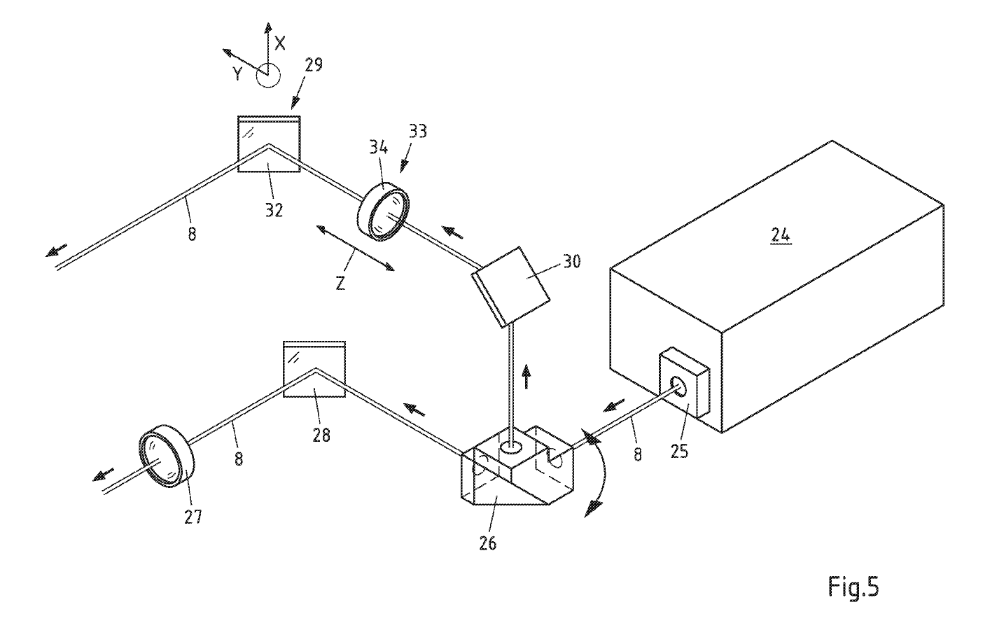

FIG. 5 a laser unit of the weakening device from FIG. 3 together with beam paths of the laser in a purely schematic representation,

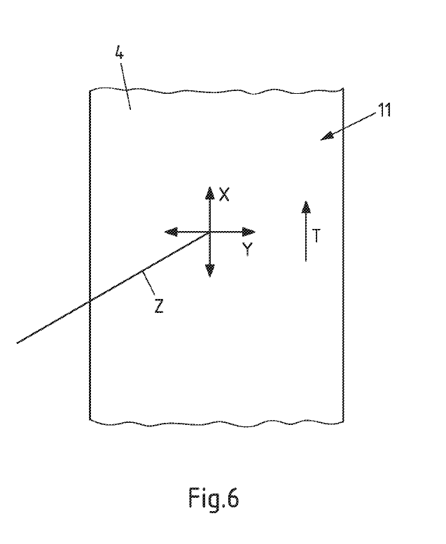

FIG. 6 a purely schematic representation of the inscribing of a line of weakness into a packaging material with the weakening device from FIG. 3 and the method according to the present invention and

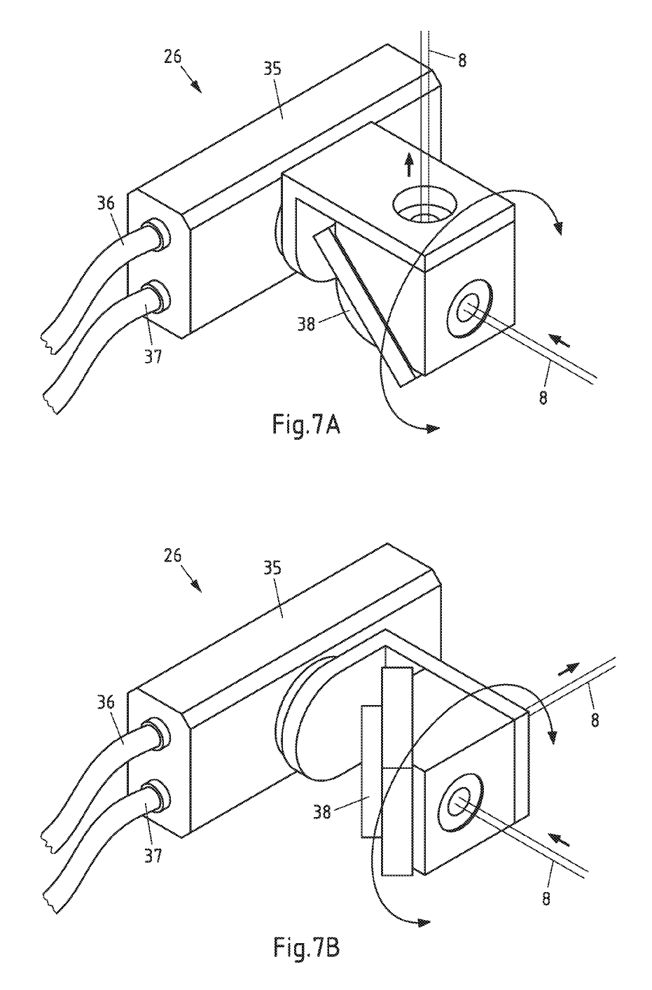

FIG. 7A-B the beam switch of the weakening device from FIG. 3 in a perspective detail view.

In FIGS. 1A-C, packaging blanks 1, 2, 3 for producing different packaging are shown. The packaging materials 4 of the packaging blanks 1, 2, 3 are designed as packaging laminates and accordingly comprise several layers of different materials. The illustrated and in this respect preferred packaging material 4 is one with outer layers made from a thermoplastic resin, in particular an olefin, particularly preferably polyethylene (PE), but if necessary also polypropylene (PP). The side of the packaging material 4 pointing outwards in the subsequent packaging and shown in FIGS. 1A-C is additionally printed. For the sake of better clarity, the print is not shown, since the process of printing packaging materials is well known. Only at the lower left, a control mark 5 in the form of an imprinted printed mark is schematically illustrated, which defines the relationship between a specific point on the packaging material 4 of a packaging material web and a specific point of the subsequent packaging blank 1, 2, 3. In particular, the control mark 5 also determines at which points the packaging material web is cut in order to produce the packaging blanks 1, 2, 3. This ensures that the printed decoration is always provided in the designated place and in the intended manner on the packaging.

The illustrated and in this respect preferred packaging blanks 1, 2, 3 also have what are known as score lines 6 or pre-fold lines, on which the packaging material 4 or the packaging blank 1, 2, 3 is folded to form the packaging. This simplifies the formation of the packaging and ensures that the packaging is produced with the desired quality and shape. Frequently, but not necessarily, the layers of the packaging material laminate are first laminated to form a packaging material web and rolled up into packaging material rolls. Subsequently, the packaging material web is unrolled again to be printed. The printed packaging material web is frequently rolled up again into a packaging material roll. After the packaging material web is again unrolled from the packaging material roll, the packaging material web is provided with lines of weakness 7 and then with the score lines 6 or pre-fold lines. Subsequently, the packaging material web is cut longitudinally and transversely to form the individual packaging blanks 1, 2, 3. Typically, not only the subsequent packaging blanks 1, 2, 3 are provided behind one another in the longitudinal direction on a packaging material web. Rather, several rows of subsequent packaging blanks 1,2,3 are provided adjacent to each other on the packaging material web. The number of rows can be chosen arbitrarily. However, two, four or six adjacent rows have proved to be particularly expedient.

The packaging blanks 1, 2, 3 shown in FIGS. 1A-C differ with regard to the shape of the lines of weakness 7 introduced into the respective packaging material 4. The lines of weakness 7 are lines along which the layer thickness of the packaging material 4 is at least partially reduced, as a result of material removal. The removal of material is brought about by inscribing the packaging material 4 with a laser beam 8, wherein the packaging material 4 absorbs so much energy that certain parts of the packaging material are vaporised and, if necessary, other parts of the packaging material are blast off by vaporisation. In the packaging laminates shown in FIGS. 1A-C, the lines of weakness 7 are shown as dashed lines and also inscribed in dashed lines in the packaging material. Short weakened sections of the lines of weakness 7 are recurrently followed by short unweakened or hardly weakened sections and vice versa.

In FIG. 1A, the line of weakness 7 is provided in a straight line and continuously over the entire packaging blank 1. The line of weakness 7 is aligned parallel to the transport direction of the packaging material web along the laser beam 8. The present line of weakness 7 is a line of weakness 7, which forms what is referred to as a one-dimensional shape, even if the line of weakness 7 as a matter of course extends at least in sections in a direction perpendicular to the line of weakness 7 and parallel to the packaging material 4 as well as in a direction perpendicular to the line of weakness 7 and perpendicular to the packaging material 4. Nevertheless, the line of weakness 7 extends in a straight line along the packaging blank 1. Due to the straight line of weakness 7, the subsequent packaging can simply be torn open over the entire length at the top of the packaging in order, for example, to be able to pour out foodstuffs packaged therein.

On the other hand, the lines of weakness 7 of the packaging blanks 2, 3 illustrated in FIGS. 1B-C form a two-dimensional shape 9, 10. Namely, the lines of weakness 7 extend at least also in a direction perpendicular to the transport direction of the packaging material web and parallel to the packaging material 4. In the packaging blank 2 according to FIG. 1B, the line of weakness 7 forms a circle. The packaging material 4 can be pressed in along the line of weakness 7, for example through a spout provided above, in order to be able to pour out the foodstuff packaged in the packaging. If required, the shape 9 of the line of weakness 7 could be inscribed into the packaging material 4 in a form different from a circle and/or not closed.

The line of weakness 7 of the packaging blank 3 shown in FIG. 1C likewise forms a two-dimensional shape 10, namely an approximately V-shaped form adjacent to an edge of the packaging blank 3. This line of weakness 7 subsequent makes it possible to tear off a corner from the packaging in order to be able to pour out a packaged foodstuff, for example, through the opening in the packaging thus formed. Other lines of weakness 7 are also conceivable.

FIG. 2 shows a packaging material web 11 after the introduction of score lines 6 into the packaging material 4. In practice, the packaging material web 11 also has a printed decoration and the lines of weakness 7. The lines of weakness 7 and the decoration have been omitted for the sake of clarity, however, in FIG. 2. Only the control marks 5 in the form of imprinted printed marks are shown, which are separately printed on the illustrated packaging material web 11 for each of the subsequent packaging blanks 12. The transport direction T of the packaging material web 11 extends from right to left in the packaging material web 11 shown in FIG. 2. In the transport direction T four subsequent packaging blanks 12 are provided side by side. In other words, the packaging material web 11 can be cut in the longitudinal direction or in the transport direction T of the packaging material web 11 into four partial webs, along which a row 13 of subsequent packaging blanks 12 are respectively provided. Each of these partial webs can then be divided transversely to the partial web to form the individual packaging blanks 12.

FIG. 3 shows an weakening device 14 for introducing lines of weakness 7 into a packaging material web 11. The packaging material web 11, which has been printed but not yet provided with lines of weakness 7 or score lines 6, is unrolled from a packaging material roll 15 and transported past at least one sensor 16, which in the illustrated and in this respect preferred weakening device 14 is an optical sensor 16. The transport speed of the packaging material web 11 is regulated or detected as needed. If the transport speed of the packaging material web 11 is predetermined or known, and the at least on sensor 16 has also detected where control marks 5 are located on the packaging material web 11, it is clear when the laser units 17 must begin a line of weakness 7 and how the laser beam 8 must be guided for inscribing the line of weakness 7 so that the lines of weakness 7 are respectively present at the desired location and in the desired shape on the packaging blanks 12. For the respective control of the laser units 17, a control device 18 is provided which, upon detection of at least one control mark 5 by the at least one sensor 16, receives a corresponding signal from the sensor 16.

For inscribing the lines of weakness 7 on the packaging material web 11 four laser units 17 are provided in the illustrated and in this respect preferred weakening device 14. The laser units 17 inscribe lines of weakness 7 in rows 13 on the packaging material web 11, arranged adjacent to each other and transverse to the transport direction T of the packaging material web 11. Each of the laser units 17 is assigned to a row 13 of subsequent packaging blanks 12. In the area in which the laser unit 17 inscribes the packaging material 4 with a laser 8, the packaging material web 11 is aligned between two rollers 19 at least approximately in one plane in order to also inscribe two-dimensional shapes 10 into the packaging material 4 with the line of weakness 7, without thereby being required to take into account any possible curvature of the packaging material web 11. After the packaging material web 11 has passed all four laser units 17, all desired lines of weakness 7 are inscribed into the packaging material 4, which is subsequently fed to a scoring station, in which the score lines 6 are applied to the packaging material web 11. The packaging material 4 or the packaging material web 11 is transported past the laser units 17 by means of a transport device 39.

FIG. 4A shows a detail of the weakening device 14 from FIG. 3. Between the laser unit 17 and the packaging material web 11, an extractor hood 20 is respectively provided. Alternatively, several or all extractor hoods 20 may be combined. For the sake of clarity, the extractor hoods 20 are not shown in FIG. 3. The extractor hoods 20 are open adjacent to the packaging material web 11 and spaced apart from the packaging material web 11 by a gap 21. The extractor hoods are connected to the associated laser unit 17, wherein the laser unit 17, in particular the focussing optics 27 and/or the scanner 29, has a glass pane or a housing section 22 transparent to the laser beam 8, through which the laser beam 8 can be directed into the extractor hood 20 and towards the packaging material 4. The extractor hood 20 thus comprises, if necessary, the transparent pane or the transparent housing section 22 of the laser unit 17. In other words, the extractor hood 20 adjoins the transparent pane or the transparent housing section 22 of the laser unit 17. The extractor hood 20 is also associated with an exhaust 23, via which air is withdrawn from the extractor hood 20, which extracts the packaging material 4 removed by the laser 8.

FIG. 4B shows a similar detail as in FIG. 4A of an alternative weakening device, for which reason the same reference numerals are used. Between the laser unit 17 and the packaging material web 11, an extractor hood 20 is provided, which is spaced apart from the laser unit 17 and has a transparent pane or a transparent housing section 22 through which the laser beam 8 can enter the extractor hood 20 and reach the packaging material. A connection between the extractor hood 20 and the associated laser unit 17 is not required. The extractor hood 20 shown in FIG. 4B is also open adjacent to the packaging material web 11 and is spaced apart from the packaging material web 11 by a gap 21. The extractor hood 20 is also similarly assigned an exhaust 23, via which air is withdrawn from the extractor hood 20, which extracts the packaging material 4 removed by the laser 8.

In FIG. 5, the laser unit 17 of the weakening device 14 is shown schematically. The laser unit 17 comprises a laser 24 or a laser source for generating a laser beam 8. The laser 24 first passes through a shutter 25 in its beam path. The shutter 25 closes and opens repeatedly at very short intervals. When the shutter 25 is closed, the laser beam 8 does not pass through the shutter 25. However, when the laser beam 8 is opened, the laser beam 8 does pass through. If the shutter 25 is open for a longer period of time and closed for a shorter period of time, more energy is transferred to the packaging material 4 and vice versa. After passing through the shutter 25, the laser beam 8 enters a beam switch 26, which can occupy two positions. In the liner position, the laser beam 8 is directed to a focussing optics 27, which focuses the laser beam 8 onto the plane of the packaging material 4. In the illustrated and in this respect preferred laser unit 17, a deflection mirror 28 is provided between the beam switch 26 and the focussing optics 27. With the beam switch 27 in the liner position, the laser beam 8 of the laser unit 17 inscribes a straight line of weakness 7 in the packaging material 4. Thus, for example, packaging blanks 1 according to FIG. 1A can be obtained.

In order to obtain packaging blanks 2, 3 according to FIGS. 1B-C, the beam switch 26 must be adjusted from the liner position to the scanner position. In the scanner position, the beam switch 26 directs the laser beam 8 entering the beam switch 26 onto a scanner 29. In the illustrated and in this respect preferred laser unit 17, the laser beam 8 also passes through a fixedly mounted deflection mirror 30 and a further focussing optics 33. Both could in principle be dispensed with or could be provided elsewhere in the beam path.

The scanner 29 has, in the illustrated and in this respect preferred laser unit 17, a mirror 32 which can be pivoted about two mutually perpendicular axes. In principle, however, two separate mirrors pivoting respectively about a different axis could be provided. By adjusting the mirror 32, the laser beam 8 can be adjusted or deflected in a direction parallel to the transport direction T of the packaging material web 11 (x-direction) and alternatively or additionally in a direction perpendicular to the transport direction T and parallel to the packaging material web 11. As a result of this deflection, lines of weakness 7 can be inscribed in the packaging material 4, forming a two-dimensional shape 9, 10.

The laser beam 8 can thus move over the packaging material 4 by an adjustment of the scanner 29, as shown in FIG. 6. The scanner 29 can be adjusted specifically parallel to the transport direction T of the packaging material 4 (x-direction) or perpendicular thereto along the packaging material 4 (y-direction). The line of weakness 7 then runs on the packaging material 4 at least also in a direction transverse to the transport direction T of the packaging material web 11.

If the laser beam 8 is deflected very far in the x-direction and/or y-direction relative to a starting position, the path of the laser beam 8 between the laser unit 17 and the packaging material 4 becomes longer in the direction of the beam path of the laser beam 8 (z-direction). In contrast, the z-coordinate becomes generally shorter when the laser beam 8 is adjusted less far from a central starting position in the x-direction and/or y-direction. Regardless of the respective deflection of the laser beam 8, the focus of the laser beam 8 should still be in the plane of the packaging material 4. Therefore, a further focussing optics 33 is provided in the beam path of the laser beam 8 passing through the scanner 29, which makes this possible. This can for example have a lens 34 which is adjustable in the direction of the beam path. The adjustment of the lens 34 can then be controlled by the scanner 29 depending on the adjustment of the laser beam 8.

In FIGS. 7A-B, the beam switch 26 is shown in detail. The beam switch 26 has a drive 35, in particular pneumatic or alternatively electric, which is designed as a pneumatic double piston drive. To move the pistons, two compressed air connections 36, 37 are provided. If compressed air is supplied to a compressed air connection 36, a mirror unit 38 of the beam switch 26 is arranged in the liner position shown in FIG. 7A, so that the laser beam 8 is directed to the focussing optics 27 and a straight line of weakness 7 is inscribed into the packaging material 4. If now another piston is supplied with compressed air via the other compressed air connection 37, the mirror unit 38 of the beam switch 26 rotates into the scanner position shown in FIG. 7B, in which the beam switch 26 directs the laser beam 8 to the scanner 29 in order to to inscribe a two-dimensional shape 9, 10 into the packaging material 4 by means of the line of weakness 7. If necessary, the mirror unit 38 can be rotated back to the liner position by renewed pressurisation of the other compressed air connection 36.

### LIST OF REFERENCE NUMERALS

1 Packaging blank
2 Packaging blank
3 Packaging blank
4 Packaging material
5 Control mark
6 Score lines
7 Lines of weakness
8 Laser beam
9 Shape
10 Shape
11 Packaging material web
12 Packaging blank
13 Row
14 Weakening device
15 Packaging material roll
16 Sensor
17 Laser unit
18 Control device
19 Rollers
20 Extractor hood
21 Gap
22 Housing section
23 Exhaust
24 Laser
25 Shutter
26 Beam switch
27 Focussing optics
28 Deflection mirror
29 Scanner
30 Deflection mirror
32 Mirror
33 Focussing optics
34 Lens
35 Drive
36 Compressed air connection
37 Compressed air connection
38 Mirror unit
39 Transporting means

1. A weakening device for weakening packaging materials having at least one laser unit comprising a laser for irradiating and partially removing the packaging material with a laser beam and having at least one transport device for transport of the packaging material relative to the at least one laser unit, wherein the at least one laser unit has at least one focusing optics for focusing the laser beam on the packaging material transported relative to the laser by the transport device,
wherein
the laser unit has at least one scanner for adjusting the laser beam in at least one direction transverse to a transport direction for inscribing predetermined shapes into the packaging material transported past the laser and in that a beam switch is provided in a beam path of the laser beam in the at least one laser unit, which transmits the laser beam optionally to the at least one focusing optics in a linear position or to the at least one scanner in a scanner position.

2. The weakening device according to claim 1,
wherein
the at least one scanner has at least one mirror adjustably arranged in the beam path for adjusting the laser beam reflected by the at least one mirror.

3. The weakening device according to claim 1,
wherein
the beam switch is configured to be adjustable at least from a liner position for directing the laser beam to the at least one focusing optics into a scanner position for directing the laser beam to the at least one scanner and back.

4. The weakening device according to claim 3,
wherein
the beam switch abuts on a stop in the liner position and/or in the scanner position.

5. The weakening device according to claim 3,
wherein
an electric drive or pneumatic drive is associated with the beam switch for adjusting the beam switch from the liner position to the scanner position and/or back.

6. The weakening device according to claim 1,
wherein
an extractor hood for extracting the packaging material removed by the laser beam is provided in the beam path and adjacent to the packaging material, and in that the extractor hood has an open housing section or a housing section transparent to the laser beam for the laser beam to enter the extractor hood.

7. A weakening device according to claim 1,
wherein
a second focusing optics is provided in the beam path passing through the scanner, and in that the second focusing optics associated with the scanner is configured for focussing the laser beam perpendicular to the packaging material in accordance with the deflection of the laser beam by the scanner in the transport direction of the packaging material and/or in a direction perpendicular to the transport direction and parallel to the packing material.

8. The weakening device according to claim 1,
wherein
at least the laser, the beam switch, the at least one focusing optics or the scanner of the at least one laser unit are mounted stationary relative to each other on a holding device of the laser unit and that the holding device is mounted adjustably in at least one direction.

9. The weakening device according to claim 1,
wherein
at least one laser unit is provided and the at least one laser unit is provided at least partially in a direction perpendicular to the transport direction of the packaging material and parallel to the packaging material adjacent to one another and/or behind one another at least partially in the transport direction of the packaging material.

10. A weakening device according to claim 1,
wherein
a sensor is provided for detecting control marks on the packaging material, in particular in the form of printed marks and/or embossed marks, and in that, preferably, a control device is provided for controlling the scanner depending on the detection, in particular the time of detection, of the control marks by the sensor.

11. A method for weakening packaging materials, the method comprising the steps of:
transporting the packaging material past at least one laser unit by a transport device;
using the at least one laser unit to generate a laser beam that irradiates the packaging material and partially removes it; and
directing the at least one laser beam by a beam switch to a focusing optics in a liner position, for focusing the laser beam towards the packaging material, or to a scanner in a scanner position, for adjusting the laser beam at least in a direction transverse to a transport direction, for inscribing predetermined shapes on the packaging material.

12. The method according to claim 11, further comprising:
impinging the energy of the laser beam on the packaging material at least temporarily varies, in particular pulses, such that different amounts of packaging material are removed at different points of the packaging material.

13. The method according to claim 11, further comprising:
inscribing a line of weakness into the packing material parallel to the transport direction of the packaging material by a laser beam passing the beam switch in the liner position; and/or
inscribing a line of weakness into the packaging material extending at least partially in a direction perpendicular to the transport direction and parallel to the packaging material by a laser beam passing through the beam switch in the scanner position.

14. The method according to claim 11, further comprising:
adjusting the laser beam passing through the scanner in a first direction during the inscribing of a shape on the packaging material; and
adjusting the laser beam passing through the scanner in a second direction during the inscribing of a shape on the packaging material.

15. A method according to claim 11, further comprising:
inscribing similar shapes into the packaging material in the form of lines of weakness, said shapes being spaced apart, and these are inscribed by means of a laser beam passing through beam switch in the scanner position; and/or
inscribing a straight line of weakness into the packaging material, said line of weakness extending in particular parallel to the transport direction of the packaging material, and interrupted in sections, and this is inscribed by means of a laser beam passing through the beam switch in the liner position.

16. The method according to claim 11, further comprising:
initiating the inscribing of a line of weakness, a part of a line of weakness and/or a shape by identifying at least one control mark by at least one sensor.

17. The method according to claim 11, further comprising:
focusing a laser beam passing through a beam switch in the scanner position by means of a focusing optics in accordance with the deflection of the laser beam in the transport direction of the packaging material and/or in accordance with the deflection of the laser beam in a direction perpendicular to the transport direction of the packaging material and parallel to the packaging material.

18. The weakening device of claim 2, wherein the at least one scanner has two mirrors which are adjustable in at least substantially vertical directions relative to one another.

19. The weakening device of claim 2, wherein the at least one mirror is configured to adjust the laser beam in the transport direction of the packaging material and at least one other mirror is configured to adjust the laser beam in a direction perpendicular to the transport direction and parallel to the packaging material.

20. The weakening device of claim 5, wherein the electric drive or pneumatic drive is a double piston drive.
